(19) United States
(12) Patent Application Publication
(10) Pub. No.: US 2005/0241392 A1
(43) Pub. Date: Nov. 3, 2005

(54) Atomic force microscope tip holder for imaging in liquid

(76) Inventor: Yuri L. Lyubchenko, Omaha, NE (US)

Correspondence Address: GALLAGHER & KENNEDY, P. A., 2575 E. CAMELBACK RD. #1100, PHOENIX, AZ, 85016, US

(21) Appl. No.: 11/077,525

(22) Filed: Mar. 9, 2005

Related U.S. Application Data
(60) Provisional application No. 60/551,731, filed on Mar. 9, 2004.

(51) Int. Cl. G01L 19/14

(52) U.S. Cl. 73/431; 73/105

(57) ABSTRACT

An atomic force microscope (ARM) tip holder includes a vessel open at the bottom with gas-tight walls and top. A piezoelectrically activated cantilever vibratory tip holder is secured at one end within the vessel and extends to a tip-holding end at a location proximate a liquid level established when the vessel is placed open end downward in a liquid trapping air or gas. Only a small portion of the tip extends into the liquid to contact the specimen for examination by e.g. “tapping mode” AFM. Presence of the cantilever and part of the tip in gas virtually eliminates the loss of performance encountered with liquid submersion.

### CROSS REFERENCE TO RELATED APPLICATIONS

This application claims priority from U.S. provisional patent application Ser. No. 60/551,731 of the same title, filed Mar. 9, 2004 in the name of Yuri Lyubchenko. That application is hereby incorporated herein by reference.

### FIELD OF THE INVENTION

This invention relates to an atomic force microscope (AFM) tip holder and more particularly to an AFM tip holder for imaging in liquid.

### BACKGROUND

Atomic force microscopes reveal the microscopic structure of a variety of materials to the nanometer. This tool has become essential for characterizing the surface of numerous materials including biological materials.

Biological material samples such as DNA, living cells, and proteins must remain immersed in liquid (reproducing the sample's normal physiological conditions) during imaging in order for the sample to live and retain its inherent biological characteristics. Most often a tapping mode technique is used to image biological samples in liquid in order to prevent significant damage to the sample which is soft and fragile. Ando et al., “A high-speed atomic force microscope for studying biological macromolecules,” PNAS, Oct. 23, 2001 (Vol. 98, No. 22), (incorporated herein by reference) describe the “tapping mode” AFM imaging of molecules. Hallett et al., in “Improvements in atomic force microscopy protocols for imaging fibrous proteins,” J. Vac. Sci. Technol. March/April 1996 (p. 1444) (incorporated herein by reference), describe tapping mode AFM imaging of proteins in liquid. In tapping mode, an AFM cantilever is positioned above the surface of a sample and oscillated at its natural resonant frequency by means of a piezoelectric stack so that a cantilever tip taps the surface of the sample only for a small fraction of the oscillation period. The tip-sample interaction is measured through changes in the amplitude, phase, and/or resonant frequency of the oscillation. This tip-sample interaction is mapped into the surface topography of the sample through any of several AFM detector means well known in the art and not a part of the invention here.

Current AFM technique imaging biological specimens in liquid uses a generally similar design in which the tip scanning the specimen is fully submerged in the liquid. Sulchek et al., “High-speed atomic force microscopy in liquid,” Review of Scientific Instruments, May 2000 (Vol. 71, No. 5) (incorporated herein by reference) describe shortcomings of AFM scanning in liquid as compared to air.

Liquids are more viscous than air, and therefore, create more drag on the cantilever and cantilever tip as they oscillate in the liquid. This impacts the imaging process in several negative ways. The cantilever moves more slowly, or at a decreased frequency. The movement of the cantilever in liquid causes significant background “noise” in the tip-sample interaction measurements and makes it harder to determine the natural resonant frequency of the cantilever. These in turn affect the accuracy and resolution of the resulting surface image.

When the tip and supporting cantilever oscillates in the more viscous liquid medium (i) a large volume of the liquid is disturbed, (ii) the resonant peak is widened greatly complicating lateral resolution in the imaging, and (iii) desired faster scanning is complicated or prevented by the slowing of the cantilever and tip and the further difficulties of AFM scanning in liquid.

A further problem in liquid imaging is commonly referred to as the “forest of peaks.” When the cantilever and tip oscillate in liquid, the viscous liquid causes mechanical resonance in the cantilever and tip itself, which in turn introduces numerous sharp peaks in a cantilever's response spectrum (graph of amplitude versus frequency). The “forest of peaks” introduced into the response spectrum masks the major peak that corresponds to the cantilever's natural resonant frequency.

### BRIEF SUMMARY OF THE INVENTION

The present invention is an AFM tip holder for imaging in liquid using the well-known phenomenon of excluding liquid from an open bottom sealed vessel when it is immersed into the liquid well below the liquid level.

The present invention is an apparatus that maintains most of an AFM's cantilever tip and the entire cantilever in air (or other environmental gas), rather than in the more viscous liquid. This thereby reduces and/or virtually eliminates the negative effects discussed above, leading to higher-resolution images of samples in liquid. Specifically, with most of the cantilever tip and cantilever moving through less viscous air or gas, a higher drive frequency can be used in imaging as much as three to five times that in liquid. A high drive frequency allows for faster scanning which in turn can allow for study of the dynamic behavior of biological materials (“fast-scanning AFM”). A narrow resonant peak very close to that accomplished scanning in air can be expected.

Importantly, maintaining most of the cantilever and cantilever tip in air as it oscillates eliminates the “forest of peaks,” making the one major peak corresponding to the cantilever's natural resonant frequency easily identifiable. Oscillating the cantilever and tip in air rather than liquid typically increases the accuracy of the natural resonant frequency determination by a factor of 10. Accurate identification of the cantilever's natural resonant frequency is important because oscillation at the natural resonant frequency allows for high-resolution imaging of the sample surface and faster imaging.

The present tip holder invention can also be used for active cantilevers operating in air without any modification, which may further lend to the development of faster AFM scanning of biological subjects in liquid. This can be important because biological specimens such as live cells can rapidly change. Also, when using the tip holder of the present invention, if the level of the liquid in which a specimen is retained varies considerably, very little variation of the liquid level at the scanning tip occurs.

The above and further objects and advantages of the invention will be better understood from the following detailed description of at least one preferred embodiment of the invention, taken in consideration with the accompanying drawing.

### BRIEF DESCRIPTION OF THE DRAWING

FIG. 1 is a diagrammatic, partly cross-sectional view of the AFM tip holder of the invention, not to scale.

### DETAILED DESCRIPTION OF THE INVENTION

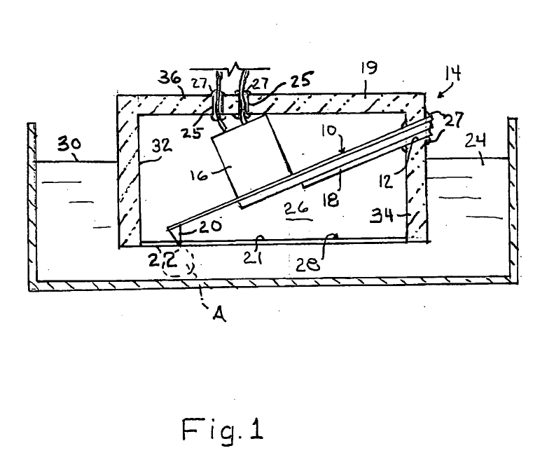

Referring to FIG. 1, in a preferred exemplary embodiment of the present invention, an AFM cantilever 10 is mounted in a slot 12 at the top of a fully-sealed tip holder 14 and pressed against a piezoelectric stack 16 with a spring 18. As used herein, “fully-sealed tip holder” is meant a tip holder open at the bottom where it is immersed into a liquid 24, but the interior 26 of which is sealed against the escape of air or other environmental gas. The fully sealed tip holder 18 includes a vessel 19 having an opening 28 at its bottom and gas tight walls 32 and 34 (which walls may be a single cylindrical or conical wall) and top 36. The vessel may be of glass, ceramic or other material, but should be transparent to laser light if laser detection of the nature taught, for example by the above-referenced writing of Sulchek et al. The piezoelectric stack and spring mechanism serve to oscillate the cantilever. A tip 20 is attached to the free end of the cantilever 10, and the cantilever 10 is mounted in such a way that only a small part of the tip 20 itself is below a liquid level 21 proximate to or at a bottom edge 22 of the vessel 19. The slot 12 into which the cantilever 10 is mounted and any pass-throughs 25 of electrical leads to the piezoelectric can be sealed using any of a number of commercially available sealants 27, such as a sealing wax, a silicon rubber compound, etc.

When the tip holder 14 is immersed into the liquid 24 in which a biological sample rests, the liquid level 21 within the tip holder raises up at a value considerably less than the liquid level 30 outside the tip holder. Put another way, partial immersion of the tip holder 14 depresses the liquid surface at the level 21 allowing it to rise within the holder 14 only an amount permitted, by the compression of the air or other contained gas. It is estimated that if an air-filled tip holder 14 is immersed 2 millimeters into the liquid, the level of the liquid inside the tip holder raises less than 1 micrometer. This is only one-tenth of the cantilever tip height if the height of the pyramidal or conical cantilever tip 20 is 10 micrometers. The level raises another 2 micrometers if the tip holder 14 is moved down an additional 3 millimeters into the liquid (5 millimeters total). If the bottom of the cantilever tip 20 is exactly even with the lower rim 22 of the vessel 19, the major part of the cantilever tip 20 remains above the liquid level 21 and the entire cantilever 10 resides above the liquid and does not touch the liquid while the scanning is performed.

Whereas a specific, preferred exemplary embodiment of the invention has been described above, it will be apparent to those skilled in the art to which the invention pertains that modifications may be made without departure from the spirit and scope of the invention. For example, although the means by which the cantilever is supported within the vessel 19 is described in accordance with the above exemplary embodiment as a slot, molded in place, internal mounting provisions to secure the cantilever, the spring and the piezoelectric stack using suitable fasteners or a suitably chosen adhesive may be employed without departing from the invention. Alternatively, subsequently drilled holes that accommodate fasteners extending through the walls or top of the vessel 19 to retain the internal component or components in place can be employed, again without departure from the invention. These holes would, of course, be sealed by a suitable sealant, as previously described.

Also, while in the above-described exemplary embodiment, the cantilever 19, the piezoelectric activator 16 and the spring 18 are distinct components, Sulchek et al. in the writing cited above, describe an integrated cantilever and piezoelectric element that could be used without departure from the present invention.

Further modifications, alterations and additions to the invention embodiments disclosed may be made without departure from the spirit and scope of the invention as set forth in the appended claims.

1. An atomic force microscope tip holder comprising:
(a) a vessel having;
(i) gas-tight sides and top,
(ii) a bottom opening defining a liquid level when the vessel is inserted bottom-first into a liquid trapping a gas therein,
(b) a vibratory cantilever supported within the vessel and having a supported end above the liquid level and an atomic force microscope tip-bearing end;
(c) vibratory motive means for imparting vibratory motion to the cantilever; and
(d) the atomic force microscope tip-bearing end of the cantilever being located at or proximate the liquid level of the vessel, whereby upon insertion of the vessel bottom-first into a specimen-containing liquid, an atomic force microscope tip borne by the cantilever has at least a portion thereof within the liquid for contact with a specimen contained in the liquid.

2. The atomic force microscope tip holder according to claim 1, wherein only a portion of the tip borne by the cantilever is located below the liquid level.

3. The atomic force microscope tip holder according to claim 1, wherein the vibratory motive means is a piezoelectric activator located within the vessel and connected with the cantilever.

4. The atomic force microscope tip holder according to claim 3, further comprising a spring connected with the cantilever and with the piezoelectric activator operative to impart with the piezoelectric resonant vibratory motion to the cantilever and to the tip carried thereon.

5. The atomic force microscope tip holder according to claim 1, wherein a major portion of the tip lies above the liquid level.

6. The atomic force microscope tip holder according to claim 5, wherein between approximately 10% and approximately 30% of the length of the tip lies below the liquid level.

7. An atomic force microscope tip holder, comprising:
(a) a vessel having an open bottom, and sealed closed sides and top for containing a gas; and
(b) means for supporting within the vessel a vibratory atomic force microscope cantilever tip support at a location and in a direction locating an atomic force microscope tip on the cantilever tip support at a level proximate the vessel open bottom.

8. The atomic force microscope tip holder according to claim 7, wherein the means for supporting comprises means for holding the cantilever tip support extending to at least proximate the open bottom of the vessel to place an atomic force microscope tip at a location to partially extended into a liquid into which the vessel is placed.

9. A method of atomic force microscope imaging of a biological specimen in a liquid comprising;
(a) providing an atomic force microscope tip holder having a vessel open at the bottom and closed to the escape of gas at sides and top,
(b) supporting a cantilever that is vibratory at a resonant frequency within the vessel with a tip-holding end extending to a liquid level proximate the open bottom of the vessel,
(c) lowering the vessel into a biological specimen containing liquid to bring a lower extremity of the tip into close proximity or contact with the specimen while an upper portion of the tip and the cantilever remain above the liquid level within entrapped gas in the vessel and
(d) imparting resonant vibratory motion to the cantilever and tip.

10. The method according to claim 9, wherein imparting resonant vibratory motion to the cantilever and tip comprises imparting the resonant vibratory motion at a frequency substantially the resonant vibratory frequency of the cantilever and tip in air.

11. The method according to claim 9, wherein imparting resonant vibratory motion comprises providing a piezoelectric activator in force communicating relation to the cantilever and applying resonant vibratory inducing force from the piezoelectric activator to the cantilever.

12. The method according to claim 11, wherein applying resonant vibratory inducing force effects tapping of the specimen by the tip.

13. The method according to claim 11, wherein supporting a cantilever within the vessel with a tip-holding end extending proximate the open end of the vessel comprises locating the tip with a major portion thereof above the liquid level.

14. The method according to claim 13, wherein the tip is supported with less than approximately 50% below the liquid level.

15. The method according to claim 13, wherein the tip is supported with between approximately 10% and approximately 30% below the liquid level.
